(19) United States
(12) Patent Application Publication
(10) Pub. No.: US 2003/0229740 A1
(43) Pub. Date: Dec. 11, 2003

(54) Accessing resources in a microprocessor having resources of varying scope

(76) Inventors: John Warren Maly, LaPorte, CO (US); Ryan Clarence Thompsosn, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/166,878

(22) Filed: Jun. 10, 2002

(51) Int. Cl. G06F 13/00

(52) U.S. Cl. 710/107

(57) ABSTRACT

A system is disclosed which includes a microprocessor design having a plurality of representations of machine resources of varying scope. The microprocessor design may, for example, have multiple cores and/or be capable of executing multiple threads in hardware. Machine resource representations in the microprocessor design may be limited in scope to a particular thread in a particular core, be shared by multiple threads within a core, or be shared by all threads in all cores. A software routine is provided which allows machine resource representations of varying scopes to be referenced with a fixed number of parameters. When the routine is called with a particular set of parameters, the resource scope referenced by the parameters is determined, and any machine resource representations that are referenced by the parameters are identified. A value may be read from or written to the machine resource representation.

### BACKGROUND

1. Field of the Invention

The present invention relates to integrated circuit design and, more particularly, to the design of multi-thread and/or multi-core microprocessors.

2. Related Art

Computer processors historically have been limited to executing a single instruction stream—referred to as a “thread”—at a time. Execution of multiple threads simultaneously in hardware has typically required the use of multiple processors configured in a multi-processing (MP) architecture. It typically has been necessary for operating systems and other software to be specially programmed to take advantage of the performance gains made possible by multi-processing.

Recently, processor architectures have been developed which enable a single processor to execute multiple threads concurrently (referred to herein as “hardware multi-threading”). For example, Intel Corporation's Hyper-Threading technology allows a single processor to execute multiple threads concurrently, thereby acting as if it were two physical processors. Processors enabled with Hyper-Threading technology can manage incoming instructions from different software applications and continuously switch from one set of instructions to the other, every few nanoseconds, without losing track of the state of each set of instructions. Hyper-Threading Technology complements symmetric multi-processing (SMP) by allowing more threads to execute simultaneously per processor. Hyper-Threading technology is implemented, for example, in Intel's Xeon™ line of server processors.

More specifically, a processor based on Hyper-Threading technology implements two architectural states on a single processor core. Although each of the two logical processors has a distinct architectural state, they both share the processor core's single set of execution resources. The two logical processors may execute distinct threads concurrently. The architectural state that is duplicated for each logical processor includes data registers, segment registers, control registers, debug registers, Advanced Programmable Interrupt Controller (APIC) registers, and some machine-specific registers (MSRS). The execution resources shared by the logical processors include the execution engine, the caches, the system bus interface, and the firmware. After power-up and initialization, each logical processor may be individually halted, interrupted, or directed to execute a specific thread, independently of the other logical processor on the chip.

A single processor implementing Hyper-Threading technology will appear to operating systems and other software as if it were two distinct physical processors. Operating systems and other software may therefore interact with (e.g., schedule threads on) the two logical processors in the same way that they interact with physical processors in conventional multi-processing systems. Software that is already designed to run on a conventional multi-processing system may therefore run unmodified on a Hyper-Threading platform. In such a platform, the threads that would be dispatched to two or more physical processors in a conventional multi-processing system are dispatched to the two logical processors. Because two threads executing in two logical processors on a single physical processor share one set of execution resources, one thread may use execution resources that would otherwise be idle if only one thread were executing on the physical processor. The result is an increased utilization of the execution resources within each physical processor. Modern operating systems (such as Microsoft Windows® and Linux®) and other high-performance software which is already optimized for multi-threading and multi-processing environments may especially benefit from technologies such as Hyper-Threading.

Similarly, multi-core processors include multiple processor cores in a single chip package. A multi-core processor acts as if it were multiple processors. Each of the multiple processor cores may essentially operate independently, while sharing certain common resources, such as a cache. Multi-core processors therefore provide additional opportunities for increased processing efficiency. A single processor chip may include multiple cores, each of which may provide hardware multi-threading.

Various electronic design automation (EDA) software tools exist for designing microprocessors and other circuitry. Such tools allow circuit designers to create and modify virtual models of the circuit being designed. A circuit designer may, for example, specify a circuit design using a textual description written in a hardware description language (HDL), such as Verilog or VHDL, or by using a graphical user interface to manipulate a graphical representation of the circuit design.

Software tools are also used frequently for testing circuit designs. Circuit testing tools typically simulate the operation of the circuit design; the portion of the testing tool that performs this simulation is therefore called a “simulator.” To test a microprocessor design, for example, the circuit designer typically creates one or more “test cases.” A test case typically specifies a set of initial values for machine resources (such as registers, caches, and main memory) and a set of test microprocessor instructions for the simulator to execute. The test case may also include the outputs that are expected to result from performing the test instructions based on the initial values.

A software program called an “initializer” reads the test case and modifies the initial state of the simulated processor design to reflect the initial state values specified by the test case. Once the processor design is initialized, the simulator simulates the execution of the instructions specified by the test case and verifies that the expected output is produced as a result. A significant advantage of using such simulators for testing is that they may detect errors prior to the costly and time-consuming fabrication of the circuit itself.

In a multi-core and/or multi-thread architecture, certain resources—such as registers, caches, and main memory—may be shared by multiple cores and/or multiple threads. The “scope” of a resource refers to the extent to which the resource is shared among cores and/or threads. For example, a particular machine-specific register (MSR) may be shared (available for use) by all processor cores on a chip (and by all threads within all of the cores). Such a resource is therefore said to have a “chip-wide” or “chip-specific” scope. An MSR may also be specific to (i.e., only available for use by) a particular one of the processor cores (including all of the threads in that core). Such an MSR is said to have a “core-wide” or “core-specific” scope. Similarly, an MSR may be specific to (i.e., only available for use by) a particular thread in a particular one of the processor cores. Such an MSR is said to have a “thread-wide” or “thread-specific” scope. Different resources within the same processor may have different scopes. This is referred to herein as a “mixed-scope machine resource” environment.

Computer resources are typically referred to by resource identifiers. A test case, for example, typically specifies initial values for machine resources by providing, for each resource, a resource identifier and an initial value for the resource. The identifier may, for example, be a label or other resource identifier, such as a register number in the case of a register or a memory address in the case of a memory location.

In a single-core, single-thread architecture, a single resource identifier (such as a register number) uniquely refers to a single resource. In a multi-core and/or multi-thread architecture, however, it may be necessary to use a combination of a core identifier, thread identifier, and resource identifier (e.g., register number) to uniquely identify a particular resource (e.g., register) within a particular core and thread.

When a test case refers to a resource, such as an MSR, the test case may “under-specify” the resource. For example, the test case may refer to an MSR using only a core number, rather than using a combination of core number, thread number, and MSR number. Such a reference may be ambiguous, because it may not be clear whether the reference is intended to refer to a core-specific MSR (and hence to that MSR in all threads) or to an MSR in a particular thread in that core. Conversely, a test case reference may “over-specify” a resource, such as by specifying a combination of core number, thread number, and MSR number even though no thread-specific MSR matching the reference exists. In both of these cases it is necessary for tools such as initializers and simulators to interpret the test case reference so that appropriate resource values may be initialized for the simulator. Existing tools do not provide automated techniques for performing such interpretation.

What is needed, therefore, are improved techniques for interpreting references to computer resources in mixed-scope computer architectures.

### SUMMARY

A system is disclosed which includes a microprocessor design having a plurality of representations of machine resources of varying scope. The microprocessor design may, for example, have multiple cores and/or be capable of executing multiple threads in hardware. Machine resource representations in the microprocessor design may be limited in scope to a particular thread in a particular core, be shared by multiple threads within a core, or be shared by all threads in all cores. A software routine is provided which allows machine resource representations of varying scopes to be referenced with a fixed number of parameters. When the routine is called with a particular set of parameters, the resource scope referenced by the parameters is determined, and any machine resource representations that are referenced by the parameters are identified. A value may be read from or A written to the machine resource representation.

For example, in one aspect, a method is provided for use in a system including a plurality of representations of machine resources in a microprocessor design, such as a multi-core and/or multi-thread microprocessor design. The plurality of machine resource representations have a plurality of scopes. The method includes steps of: (A) identifying a scope specified by a machine resource reference; (B) identifying a scope of one of the plurality of machine resource representations; (C) determining whether the scope specified by the machine resource reference is the same as the scope of the identified machine resource representation; and (D) assigning to the identified machine resource representation a value specified by the machine resource reference if the scope specified by the machine resource reference is determined to be the same as the scope of the identified machine resource representation.

The machine resource reference may include a value of a first parameter which specifies, for example, a thread or a core in the microprocessor design. The step (A) may include a step of determining whether the first parameter value is a NULL value. If the first parameter value is determined to be a NULL value, the method may identify the scope specified by the machine resource reference as a first scope; otherwise, the method may identify the scope specified by the machine resource reference as a second scope which is broader than the first scope. For example, if the first parameter is a “thread” parameter and the first parameter value specifies a particular thread in the microprocessor design, the method may identify the machine resource reference's scope as a thread-specified scope. If the first parameter value is a NULL value, the method may identify the machine resource reference's scope as a core-specific scope or a chip-specific scope.

The machine resource reference may include a value of a second parameter which specifies, for example, a core in the microprocessor design. The method may use techniques similar to those described above to identify the scope of the machine resource as a core-specific scope or a chip-specific scope.

The method may further include steps of: (E) determining whether the scope specified by the machine resource reference is broader than the scope of the identified machine resource representation; and (F) assigning to the identified machine resource representation the value specified by the machine resource reference if the scope specified by the machine resource reference is determined to be broader than the scope of the identified machine resource representation.

Alternatively or additionally, the method may further include steps of: (E) determining whether the scope specified by the machine resource reference is narrower than the scope of the select one of the plurality of machine resource representations; and (F) signaling an error if the first scope is determined to be narrower than the second scope. Other features and advantages of various aspects and embodiments of the present invention will become apparent from the following description and from the claims.

### BRIEF DESCRIPTION OF THE DRAWINGS

FIG. 1 is a data flow diagram of a system for initializing and testing a simulated microprocessor design according to one embodiment of the present invention;

FIG. 2 is a diagram of a machine resource database according to one embodiment of the present invention;

FIG. 3 is a block diagram of a test case according to one embodiment of the present invention;

FIG. 4A is a flow chart of a method performed by an initializer for resolving the machine resource scopes specified by a test case and for initializing machine resource values according to one embodiment of the present invention;

FIG. 4B is a flow chart of a method for assigning a value to a machine resource according to one embodiment of the present invention;

FIG. 4C is a flow chart of a method for ascertaining the machine resource scope specified by a machine resource reference according to one embodiment of the present invention; and

FIG. 5 is a block diagram of simulator input according to one embodiment of the present invention.

### DETAILED DESCRIPTION

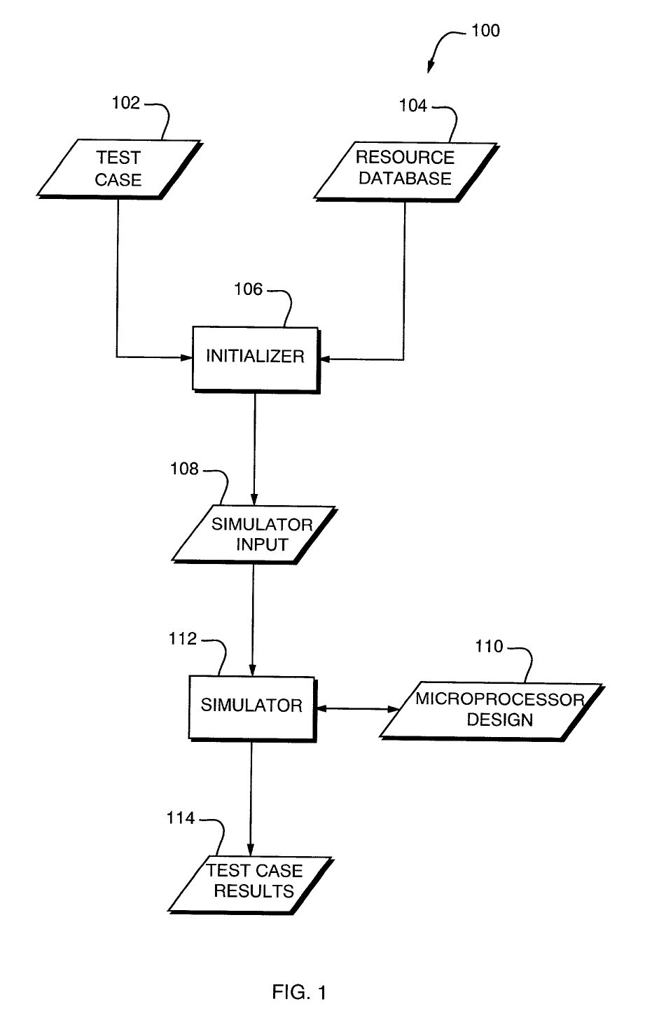

Referring to FIG. 1, a system 100 is illustrated for initializing and testing a simulated microprocessor design 110 according to one embodiment of the present invention. The microprocessor design 110, also referred to as a hardware model under test or design under test (DUT), is a software (simulated) model of a microprocessor. The microprocessor design 110 models both the operation of the microprocessor (e.g., the functional relationship between inputs and outputs of the microprocessor) and the state of the microprocessor's machine resources, such as its registers, cache(s), and main memory, at a particular point in time. The term “machine resource representation” refers herein to models of particular machine resources contained within the microprocessor design 110.

The microprocessor design 110 may have a multi-core and/or multi-thread microprocessor architecture, in which case the microprocessor design 110 models the state of each core and/or thread in the architecture. The microprocessor design 110 may be implemented, for example, in a data structure in the memory of a computer or in a file stored on a hard disk or other computer-readable medium.

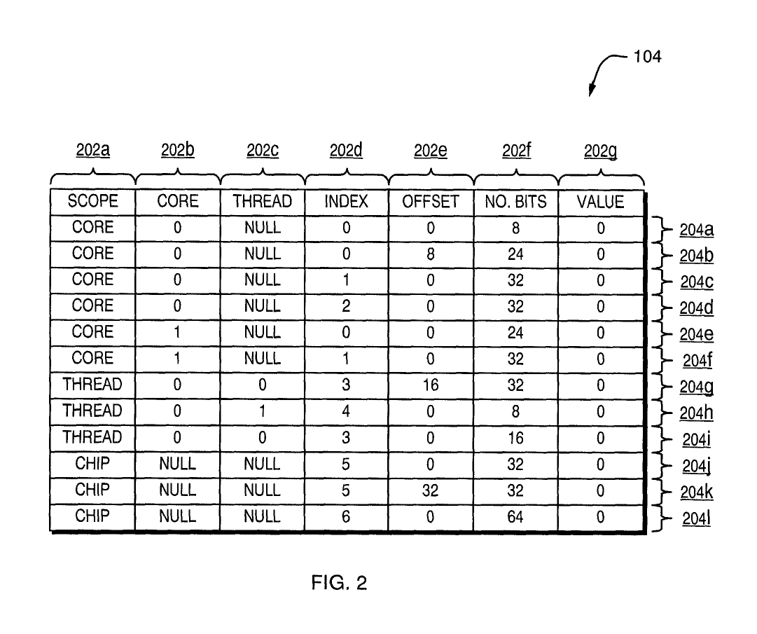

The system 100 also includes a resource database 104, which both defines the scope of each of the microprocessor design's machine resources and provides default values for each such resource. An example of the contents of the resource database 104 are described in more detail below with respect to FIG. 2.

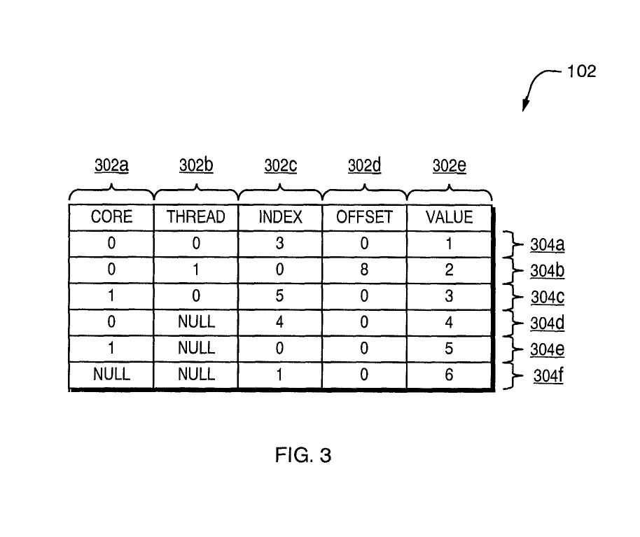

The system 100 includes a test case 102, which includes test vectors that specify both initial values for the (simulated) machine resources of the microprocessor design 110 and test instructions to be executed (in simulation) by the microprocessor design 110. The test case 102 may, for example, be implemented in a file stored on a computer-readable medium or as a data structure in the memory of a computer. Examples of initial machine resource values provided by the test case 102 are described in more detail below with respect to FIG. 3.

The system 100 also includes an initializer 106 and a simulator 112, both of which may be implemented as software programs written in any appropriate programming language, such as the C programming language. The initializer 106 initializes the state of the microprocessor design 110 based on the initial machine resource values provided in the test case 102 and the machine resource definitions provided in the resource database 104. In one embodiment, for example, the initializer 106 receives the test case 102 and the resource database 104 as inputs and produces simulator input 108 as an output. The simulator input 108 specifies the initial values of the microprocessor's machine resources, the test instructions to be executed, and the expected output produced by executing such instructions, in a format suitable for input to the simulator 112.

The simulator 112, in conjunction with the microprocessor design 110, provides an independent architectural reference model of the microprocessor. The simulator 112 receives the simulator input 108 and initializes the (simulated) machine resources of the microprocessor design 110 with the initial values specified in the simulator input 108.

Once the microprocessor design 110 has been initialized (whether by the initializer 106 or the simulator 112), the simulator 112 simulates execution of the instructions specified in the simulator input 108 on the microprocessor design 110. The simulator 112 modifies the state of the microprocessor design 110 accordingly as the simulation progresses. The simulator 112 produces test case results 114 which indicate, for example, whether the output produced by executing the test instructions matches the expected output specified by the simulator input 108.

Operation of the system 100 will be described in more detail with respect to particular embodiments of the various elements of the system 100. For example, referring to FIG. 2, one embodiment of the resource database 104 is illustrated. The resource database 104 is illustrated in the form of a table having columns 202a-g and rows 204a-l. In practice, the resource database 104 may be implemented in any of a variety of forms, such as a table generated by word processing or spreadsheet software, a header file or other source code file written in a programming language such as C, or a database file.

For purposes of example, the table illustrated in FIG. 2 defines properties of some of the machine-specific registers (MSRs) in the microprocessor design 110. In particular, each of the rows 204a-l defines a particular MSR (or sub-part thereof) and will therefore be referred to herein as an “MSR definition” or, more generally, as a “machine resource definition.” The machine resource definitions 204a-l are examples of machine resource representations, as that term is used herein.

In practice, the resource database 104 will typically define properties of all of the machine resources in the microprocessor design 110, such as the cache(s) and main memory. The techniques described herein with respect to the embodiment illustrated in FIG. 2 may therefore be applied similarly to any other kind of machine resource. Only a small number of MSR definitions are illustrated in FIG. 2 for ease of illustration and explanation. Furthermore, the particular values illustrated in FIG. 2 are chosen for illustrative purposes only.

Each of columns 202a-g represents a particular field in the machine resource definitions 204a-l. Columns 202a-g will therefore also be refereed to herein as “fields.” Scope field 202a indicates the corresponding MSR's scope. Values for the scope field 202a include CHIP (indicating chip-wide scope), CORE (indicating core-wide scope), and THREAD (indicating thread-wide scope).

Core field 202b indicates the specific core (if any) with which the corresponding MSR is associated. Thread column 202c indicates the specific thread (if any) with which the corresponding MSR is associated. The value of the core field 202b may either be a core number, indicating the core with which the corresponding MSR is associated, or the value NULL if the MSR is not associated with any single core. Similarly, the value of the thread field 202c may either be a thread number, indicating the thread with which the corresponding MSR is associated, or the value NULL if the MSR is not associated with any particular thread.

As described in more detail below, the value of an MSR definition's thread field 202c is NULL if the MSR has core-wide or chip-wide scope, and the value of an MSR definition's core field 202b is NULL if the MSR has chip-wide scope. The value NULL may be represented by any value, such as −1, which does not represent a valid core and/or thread number.

Index column 202d indicates the index (i.e., register) number of the corresponding MSR. A single MSR may be subdivided into multiple parts (referred to herein as “subparts”) of varying bit lengths, each of which may have a distinct scope. A particular MSR sub-part may be identified by a combination of its index number and an offset (in bits) within the register specified by the index number. Each of the machine resource definitions 204a-l may, therefore, definition a particular sub-part of an MSR rather than an entire MSR.

Offset column 202e indicates the offset (in bits) of the corresponding MSR sub-part within the MSR specified by the index column 202d. Note that the division of MSRs into subparts, and the consequent use of offsets, is provided herein merely for purposes of example and is not a limitation of the present invention.

Number of bits column 202f indicates the number of bits in the corresponding MSR (or sub-part). Default value column 202g which indicates a default value for the corresponding MSR (or sub-part). For purposes of example, default values of zero are shown for all of the machine resource definitions 204a-l in FIG. 2.

Although the description herein may refer to “core numbers,” “thread numbers,” “index numbers,” and “offset numbers,” these and other numbers that may be used to identify machine resources may more generally be considered to be resource identifiers, which may be numeric or non-numeric. Machine resources may, for example, be referred to by textual labels in any combination of the test case 102, the resource database 104, and the simulator input 108.

The resource database 104 will now be described in more detail with respect to representative examples of the machine resource definitions 204a-l. Consider, for example, machine resource definition 204a, which may correspond to a particular MSR in the microprocessor design 110. Scope field 202a of row 204a defines the scope of this MSR as “CORE,” indicating that the MSR has core-wide scope. The fact that the MSR defined by machine resource definition 204a has core-wide scope indicates that it is shared by all threads in its core (i.e., the core specified in core field 202b).

Core field 202b of row 204a specifies that the core number of the corresponding MSR is zero. The MSR is therefore specific to core zero. In the present example, assume that the microprocessor design 110 includes two cores, numbered 0 and 1. Thread field 202c of row 204a specifies that the thread number of the corresponding MSR is NULL. The value of the thread field 202c of definition 204a is NULL because the corresponding MSR has core-wide scope and is therefore not specific to any particular thread.

The value of the index field 202d of definition 204a is zero. In the present example, the value of the index field 202d specifies the register number of the corresponding MSR. MSRs and other registers are typically numbered sequentially beginning with zero. Therefore, definition 204a corresponds to an MSR having core-wide scope (column 202a) within core zero (column 202b) and having MSR number zero (column 202d).

Offset field 202e indicates that the corresponding MSR sub-part begins at bit zero of its MSR. Column 202f indicates that the MSR sub-part defined by definition 204a is 8 bits long. This MSR sub-part therefore occupies bits 0-7 of the corresponding MSR. Default value column 202g indicates that the default value of the MSR (sub-part) defined by definition 204a is zero.

Now consider the MSR sub-part defined by definition 204b. This MSR sub-part also has core-wide scope (column 202a) within core zero (column 202b). This MSR sub-part, however, is 24 bits long (column 202f), beginning at bit 8 (column 202e) of the MSR having index number zero (column 202d). This MSR sub-part therefore, occupies bits 8-31 of the corresponding MSR.

The next two definitions 204c-d also correspond to MSR sub-parts having core-wide scope (column 202a) within core number zero (column 202b), except that one of the MSR sub-parts (definition 204c) has an MSR number (column 202d) of one, while the other (definition 204d) has an MSR number (column 202d) of two. Definitions 204e-f define MSR sub-parts having core-wide scope (column 202a) within core number one (column 202d).

Definitions 204g-i define MSR sub-parts having thread-wide scope (column 202a). In other words, each of these MSR sub-parts is only available for use by a particular thread within a particular core of the microprocessor design 110. For example, definition 204g defines an MSR sub-part having MSR number three (column 202d) that is specific to thread number zero (column 202c) within core number zero (column 202b). The properties of the MSR sub-parts defined by definitions 204h-i should be apparent from inspection of FIG. 2 based on the explanation provided above.

Finally, definitions 204j-l define MSR sub-parts having chip-wide scope (column 202a). In other words, each of these MSR sub-parts is available for use by all threads in all cores of the microprocessor design 110. Note that the value of the core field 202b and the thread field 202c is NULL in all of these definitions 204j-l, because none of the corresponding MSR sub-parts is specific to any particular core or thread. The remaining properties of the MSR sub-parts defined by definitions 204j-l should be apparent from inspection of FIG. 2 based on the explanation provided above.

Referring now to FIG. 3, one embodiment of the test case 102 is illustrated. The test case 102 is illustrated in the form of a table having columns 302a-e (alternatively referred to as fields) and rows 304a-f. In practice, the test case 102 may be implemented in any of a variety of forms, such as a table generated by word processing or spreadsheet software, a header file or other source code file written in a programming language such as C, or a database file.

For purposes of example, the table illustrated in FIG. 3 provides initial values to be used by the initializer 106 to initialize some of the machine-specific registers (MSRs), or sub-parts thereof, in the microprocessor design 110. In practice, the test case 102 will typically include initial values for all of the MSRs (and sub-parts thereof) in the microprocessor design 110, initial values for other machine resources in the microprocessor design 110 (such as the cache(s) and main memory), and test instructions to be executed by the simulator 112. The techniques described below with respect to the embodiment illustrated in FIG. 3 may therefore be applied similarly to any other kind of machine resource. Only a selection of initial MSR values are illustrated in FIG. 3 for ease of illustration and explanation. Furthermore, the particular values illustrated in FIG. 3 are chosen for illustrative purposes only.

Each of the rows 304a-f specifies an initial value for particular MSR sub-part. The rows 304a-f are therefore referred to herein as “machine resource initialization records.” Each of the machine resource initialization records 304a-f includes: (1) a “machine resource reference,” which refers to one or more MSR sub-parts in the microprocessor design 110, and (2) an initial value for the referenced MSR sub-part.

The combination of values in fields 302a-e define a machine resource reference. For example, core field 302a indicates the core number (if any) of the corresponding MSR sub-part, thread field 302b indicates the thread number (if any) of the corresponding MSR sub-part, index field 302c indicates the index number of the corresponding MSR sub-part, and offset field 302d indicates the offset of the corresponding MSR sub-part. As described above, the combination of particular core, thread, index, and offset numbers uniquely specify a particular MSR sub-part within the microprocessor design 110. Initial value field 302e specifies an initial value for the corresponding MSR sub-part.

The test case 102 will now be described in more detail with respect to representative examples of the machine resource initialization records 304a-f. Consider, for example, initialization record 304a, which refers to an MSR sub-part having core number zero (column 302a), thread number zero (column 302b), index number three (column 302c), and offset zero (column 302d). In the present embodiment, the combination of the core number (column 302a) and thread number (column 302b) of a particular machine resource reference is referred to herein as the scope specified by the reference, or more simply as the reference's “specified scope.” For example, initialization record 304a (which includes a machine resource reference defined by the values in columns 302a-d) specifies a thread-specific scope that is limited to core zero (column 302a) and thread zero (column 302b).

Machine resource initialization record 304a refers unambiguously to the MSR sub-part defined by machine resource definition 204i (FIG. 2). To understand why this is true, consider again the resource database 100 illustrated in FIG. 2. Machine resource initialization record 304a (FIG. 3) refers unambiguously to the MSR sub-part defined by definition 204i (FIG. 2) because the values of the core fields (202b and 302a), thread fields (202c and 302b), index fields (202d and 302c), and offset fields (202e and 302d) in initialization record 304a and definition 204i match exactly. The initializer 106 may therefore initialize this MSR sub-part with the value one (FIG. 3, row 304a, column 302e) in the simulator input 108.

Consider now initialization record 304b (FIG. 3), which specifies an MSR sub-part having core number zero (column 302a), thread number one (column 302b), index number zero (column 302c), and offset eight (column 302d). The specified scope of initialization record 304b is therefore core zero, thread one, which is a thread-specific scope. Note, however, that by referring to FIG. 2 it may be seen that the MSR sub-part having index zero and offset eight (row 204b) has a core-specific scope (column 202a). The scope of an MSR sub-part (or more generally, any machine resource) as defined by the resource database 104 is referred to herein as the MSR subpart's “actual scope.” The (thread-specific) scope specified by initialization record 304b, therefore, is more specific than the (core-wide) scope of the MSR sub-part to which it refers (FIG. 2, row 204b). A machine resource reference is said to “over-specify” a machine resource when the specified scope of the reference is narrower (more specific) than the actual scope of the referenced machine resource. Initialization record 304c includes another example of a machine resource reference which over-specifies an MSR subpart.

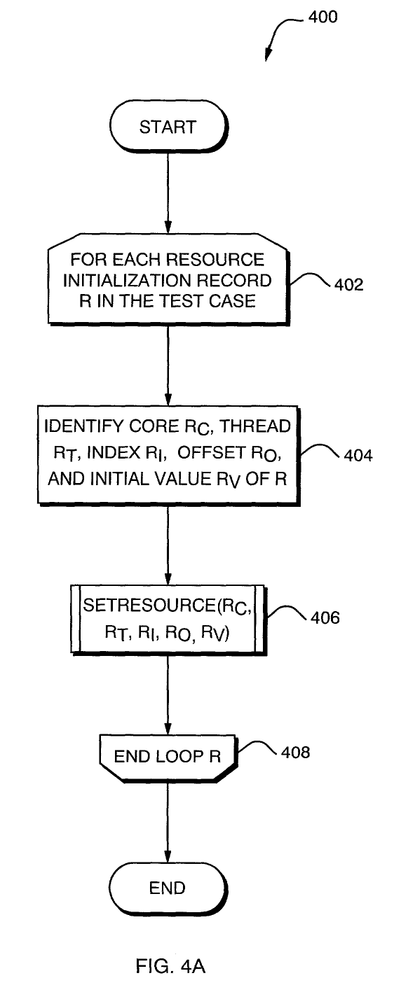

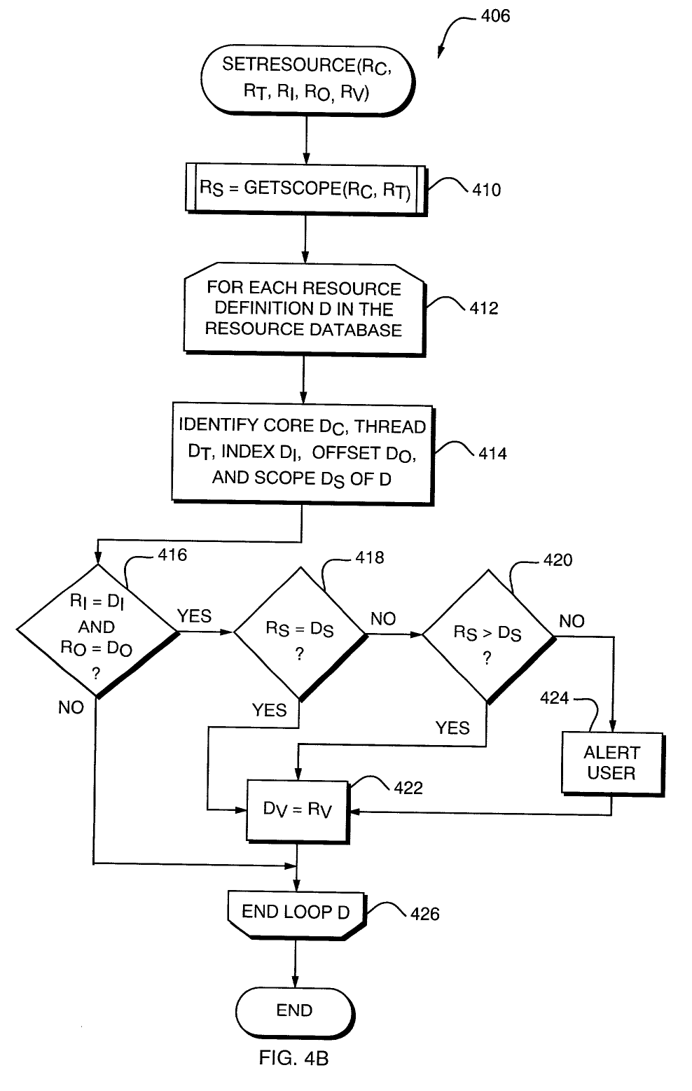

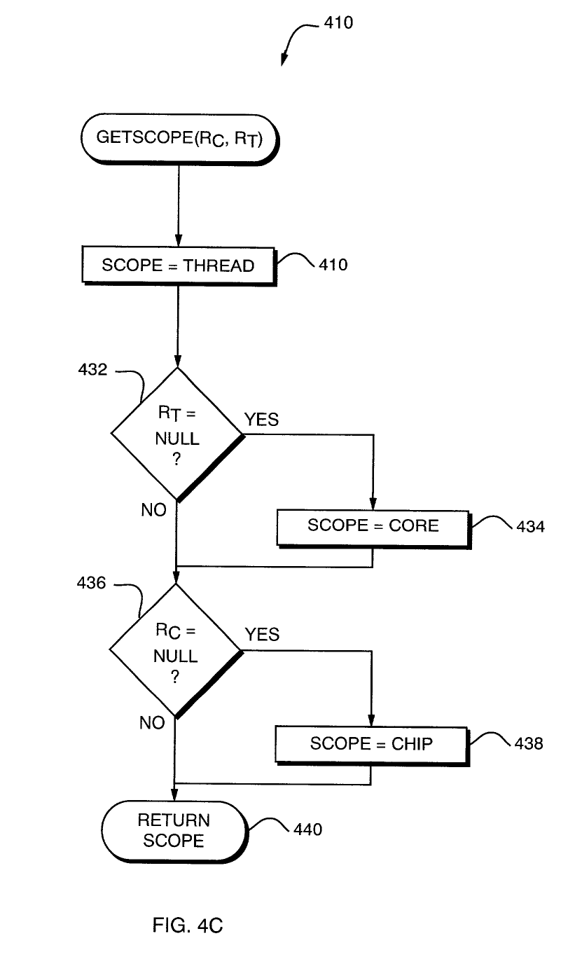

In cases where a reference over-specifies an MSR subpart, the initializer 106 may select a scope—referred to herein as a “resolved scope”—to which the corresponding initial value (FIG. 3, column 302e) is to be applied. Examples of techniques for selecting a resolved scope are described in more detail below with respect to FIG. 4B.

Consider now machine resource initialization record 304d (FIG. 3), which refers to an MSR sub-part having core number zero (column 302a), a thread number of NULL (column 302b), an index number of four (column 302c), and an offset of zero (column 302d). The specified scope of initialization record 304d is therefore core zero, which is a core-specific scope. Note, however, that by referring to FIG. 2 it may be seen that the MSR sub-part having index four and offset zero (row 204h) has a thread-specific scope (column 202a). The (core-specific) scope specified by initialization record 304d, therefore, is broader than the (thread-specific) scope of at least one MSR sub-part (FIG. 2, row 204h) to which it refers. A machine resource reference is said to “under-specify” a machine resource (e.g., an MSR) when the reference's specified scope is broader than the actual scope of the machine resource. Initialization records 304c and 304f include other examples of machine resource references which under-specify MSR sub-parts. Examples of techniques that the initializer 106 may use to select a resolved scope in cases where an MSR sub-part is under-specified are described in more detail below with respect to FIG. 4C.

Note that the mere presence of a NULL value in the core field 302a and/or thread field 302b of a machine resource reference does not necessarily mean that the reference under-specifies a particular resource. Rather, NULL values may exactly specify the scope of a resource having multi-core and/or multi-thread scope. For example, consider initialization record 304e, which specifies an MSR sub-part having core number one (column 302a), a thread number of NULL (column 302b), index number zero (column 302c), and offset zero (column 302d). The specified scope of initialization record 304e is therefore core one, which is a core-specific scope. Initialization record 304e exactly specifies the MSR sub-part defined by definition 204e (FIG. 2), which has a core-specific scope (column 202a) of core one (column 202b), an index (column 202d) of zero, and an offset (column 202e) of zero.

Referring to FIG. 4A, a flowchart is shown of a method 400 that is performed by the initializer 106 in one embodiment of the present invention to resolve the scopes specified in the test case 102 and to provide initialized resource values in the simulator input 108. The purpose of the initializer 106 is to define initial values for all of the machine resources in the microprocessor design 110 prior to execution of the simulator 112.

The method 400 enters a loop over each resource initialization record R in the test case 102 (step 402). The method 400 identifies the following values in initialization record R: the core number R_{C}, the thread number R_{T}, the index R_{I}, the offset R_{O}, and the initial value R_{V} (step 404). The method 400 may perform step 404 by extracting these values from the corresponding columns 302a-e in the row of the test case 102 containing resource initialization record R (FIG. 3).

The method 400 calls a subroutine named SetResource with the input parameters R_{C}, R_{T}, R_{I}, R_{O}, and R_{V} (step 406). As described in more detail below with respect to FIG. 4B, the SetResource subroutine 406 initializes the resource(s) referenced by R_{C}, R_{T}, R_{I}, and R_{O} with the initial value R_{V}. The method 400 repeats steps 404-406 for each resource initialization record R (step 408).

Referring to FIG. 4B, a flowchart is shown of the SetResource subroutine 406 according to one embodiment of the present invention. Although the SetResource subroutine 406 is described herein as a subroutine that is called by the method 400 (FIG. 4A), performed by the initializer 106, the SetResource subroutine 406 may be used in other contexts to set the value of a machine resource. For example, the simulator 112 may call the SetResource subroutine 406 to set the values of machine resources while simulating the operation of the microprocessor design 110.

The subroutine 406 identifies the scope R_{S} that is specified by the combination of the core number R_{C} and the thread number R_{T} by calling a subroutine named GetScope (step 410). One embodiment of the GetScope subroutine 410 is described in more detail below with respect to FIG. 4C.

The subroutine 406 enters a loop over each resource definition D in the resource database 104 (step 412). The subroutine 406 identifies the following values in resource definition D: the core number D_{C}, the thread number D_{T}, the index D_{I}, the offset D_{O}, and the scope D_{S} (step 414).

The subroutine 406 determines whether both the index and offset numbers of the resource initialization record R and the resource definition D are the same (step 416). If they are not, then the resource initialization record R does not refer to the resource defined by resource definition D and the subroutine 406 does not initialize the resource defined by resource definition D. For example, consider resource initialization record 304a (FIG. 3) and resource definition 204a (FIG. 2). The index and offset numbers specified by resource initialization record 304a are 3 and 0, respectively, while the index and offset numbers specified by resource definition 204a are 0 and 0, respectively. Resource initialization record 304a, therefore, does not refer to the resource defined by resource definition 204a.

If both the index and offset numbers of the resource initialization record R and the resource definition D are the same (step 416), the subroutine 406 determines whether the specified scope R_{S} is the same as the actual scope D_{S} of the resource defined by resource definition D (step 418). For example, consider resource initialization record 304a (FIG. 3) and resource definition 204i (FIG. 2), both of which have the same index and offset numbers. The actual scope of the resource defined by resource definition 204i is THREAD and, as explained in more detail below, the scope specified by resource initialization record 304a is also THREAD. The scope specified by resource initialization record 304a is therefore the same as the actual scope defined by resource definition 204i.

If the scopes R_{S} and D_{S} are the same, then resource initialization record R refers exactly to the resource defined by resource definition D, and the subroutine 406 initializes the value D_{V} of the resource defined by resource definition D with the initial value R_{V} specified by resource initialization record R (step 422). This may be performed, for example, by storing the initial value R_{V} in the value field 202g of the corresponding resource in the resource database 104 (FIG. 2), storing the initial value R_{V} in the simulator input 108, or storing the initial value R_{V} directly in the microprocessor design 110.

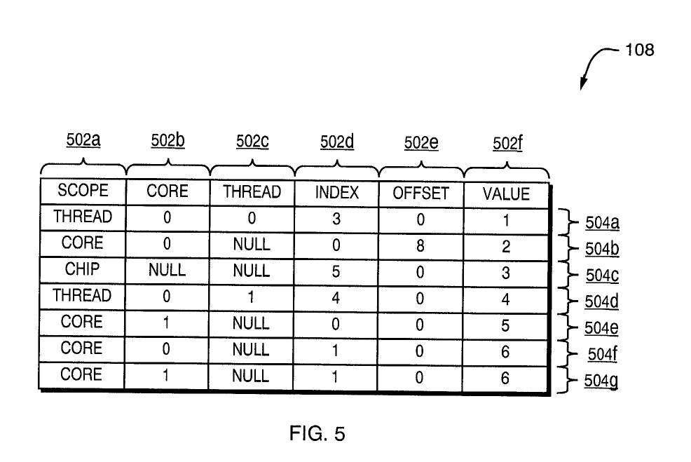

For example, referring to FIG. 5 illustrates a portion of the simulator input 108, in which the initial machine resource values specified in the test case 102 have been applied by the initializer 106 (using method 400) to the resources defined in the resource database 104. Simulator input 108 includes machine resource representations 504a-g, each of which represents the initial state of a particular machine resource (in this example, an MSR sub-part). Columns 502a-e are equivalent to columns 202a-e of the resource database 104 (FIG. 2), while value column 502f indicates the current value of the corresponding machine resource.

Machine resource representation 504a, for example, represents the MSR sub-part defined by machine resource definition 204i (FIG. 2), which is the machine resource that is referenced by machine resource initialization record 304a (FIG. 3). The current (initialized) value 502f of resource representation 504a is one, which is the initial value 302e specified by initialization record 304a (FIG. 3). This is the result of step 422 (FIG. 4B).

Returning to FIG. 4B, if the specified scope R_{S} is not the same as the actual scope D_{S} of the resource defined by resource definition D, the subroutine 406 determines whether the specified scope R_{S} is broader than the actual scope D_{S} (step 420). In other words, in step 420 the subroutine 406 determines whether resource initialization record R under-specifies the resource defined by resource definition D. In this embodiment, CHIP scope is broader than both CORE and THREAD scope, CORE scope is broader than THREAD scope only, and THREAD scope is broader than neither CHIP scope nor CORE scope.

If resource initialization record R under-specifies the resource defined by resource definition D, the subroutine 406 initializes the value D_{V} of the resource defined by resource definition D with the initial value R_{V} specified by resource initialization record R (step 422). For example, consider resource initialization record 304d (FIG. 3), which has a specified scope of CORE, and which under-specifies the resource defined by resource definition 204h (FIG. 2), which has an actual scope of THREAD. Therefore, if R were resource initialization record 304d and D were resource definition 204h, in step 422 the subroutine 406 would initialize the value D_{V} (column 202g) of the resource defined by resource definition 204h with four (as specified in the value field 302e of resource initialization record 304d). This initial value assignment is illustrated by machine resource representation 504d in FIG. 5.

The effect of steps 420 and 422 is that each resource initialization record which under-specifies one or more machine resources is used to initialize all of the machine resources (e.g., cores and/or threads) within its scope. For example, if only a core number is specified for a machine resource having thread-specific scope, the specified initial value is applied to all threads within the specified core. Similarly, if a core number is not specified for a machine resource having core-specific scope, the specified initial value is applied to all cores within the specified scope.

For example, consider resource initialization record 304f, which under-specifies the resources defined by both resource definition 204c and resource definition 204f. Subroutine 406 would therefore use the initial value (6) specified by resource initialization record 304f to initialize both resource definition 204c and resource definition 204f. This assignment of initial values is illustrated by machine representations 504f and 504g in FIG. 5. A single resource initialization record may therefore be used to initialize multiple resource representations if the resource initialization record has a broader scope than the resources it references and the same index and offset as the referenced resources.

If the specified scope R_{S} is not greater than or equal to the actual scope D_{S} of the resource defined by resource definition D, the specified scope R_{S} must be narrower than the actual scope D_{S}. In other words, resource initialization record R over-specifies the resource defined by resource definition D. In this case, the subroutine 406 alerts the user (step 424), and then assigns the initial value R_{V} to the value D_{V} (step 422). The user is alerted based on an assumption that an over-specified reference is the result of an error on the part of the designer of the test case 102. Alternatively, the subroutine 406 may terminate the subroutine 406 at step 424 or issue a warning to the user but allow the subroutine 406 to continue without assigning the initial value R_{V} to the value D_{V}.

Upon completion of step 416, 422, or 424, steps 412-424 are repeated for each of the remaining resource definitions D (step 426). Upon completion of the subroutine 406, any and all resources specified by resource initialization record R will have been initialized with the initial value R_{V}. If all resources are defined properly in the resource database 104 and all resource initialization records are defined properly in the test case 102, each resource initialization record R should always reference at least one resource defined by the resource database 104. The subroutine 406 may, however, be provided with a step (after step 426) for issuing an error message if resource initialization record R does not reference any resource defined by the resource database 104.

As mentioned above, the SetResource subroutine 406 “resolves” the scope specified by the machine resource initialization record R to determine a resolved scope. The meaning of the “resolved scope” may be better understood with respect to the embodiment of the SetResource subroutine 406 illustrated in FIG. 4B. A machine resource reference which has the same scope, index, and offset as exactly one machine resource has a resolved scope which encompasses only that machine resource (steps 416, 418, and 422). A machine resource reference which has the same index and offset as, but a broader scope than, one or more machine resources, has a resolved scope which encompasses all of those machine resources (steps 416, 418, 420, and 422). A machine resource reference which has the same index and offset as, but a narrower scope than, one or more machine resources, has an undefined resolved scope (steps 416, 418, 420, 424). This particular set of techniques for resolving machine resource scopes, however, is only one example and does not constitute a limitation of the present invention.

Referring to FIG. 4C, a flowchart is shown of the GetScope subroutine (FIG. 4B, step 410) according to one embodiment of the present invention. The GetScope subroutine 410 takes as inputs two parameters: R_{C}, a specified core number, and R_{T}, a specified thread number. The GetScope subroutine 410 determines the scope that is specified by the core number R_{C} and the thread number R_{T}. The subroutine 410 stores the specified scope in a variable named Scope, which is initialized to a value of THREAD (step 430). If the value of R_{T} is NULL (step 432), the subroutine 410 assigns a value of CORE to the variable Scope (step 434). If the value of R_{C} is NULL (step 436), the subroutine 410 assigns a value of CHIP to the variable Scope (438). The subroutine 410 returns the value of Scope to the calling routine, i.e., to the SetResource subroutine 406 (step 440).

The effect of the GetScope subroutine 410 is the following: (1) a non-NULL value for both the thread and core numbers R_{T} and R_{C} is interpreted as specifying a thread-specific scope (THREAD); (2) a non-NULL value for the core number R_{C} and a NULL value for the thread number R_{T} is interpreted as specifying a core-specific scope (CORE); and (3) a NULL value for both the thread and core numbers R_{T} and R_{C} is interpreted as specifying a chip-specific scope (CHIP).

In one embodiment, the resource database 104 is implemented as a source code file in the C programming language. In this embodiment, each of the machine resource definitions in the resource database 104 is implemented as a function call to a function which adds a machine resource representation to an internal data structure (not shown) that is maintained by the initializer 106 to represent MSR_{S} and other resources defined by the resource database 104. Such a function may have the same parameters and be similar in operation to the SetResource function 406 illustrated in FIG. 4B, except that the function may create a new machine resource representation rather than set the value of an existing machine resource representation. Those of ordinary skill in the art will appreciate how to implement such a function based on the description of the SetResource function provided herein.

The initializer 106 and the simulator 112 may be implemented as software programs written in the C programming language or any other programming language. The method 400, the SetResource subroutine 406, and the GetScope subroutine 410 may be implemented as functions in the C programming language or any other programming language. The microprocessor design 110 may be implemented as a data structure stored in the memory of a computer or on a storage medium such as a hard disk.

Among the advantages of the invention are one or more of the following.

One advantage of the techniques disclosed herein is that they may be implemented straightforwardly and efficiently in non-object-oriented programming languages, such as the C programming language. For example, tools such as initializers (e.g, initializer 106) and simulators (e.g., simulator 112) are typically implemented as software programs. Such programs need to have access to the resource database 104 and/or the microprocessor design 110 so that they may modify the state of machine resource representations (FIG. 5) by reading the existing values of machine resource representations and writing new values to machine resource representations. For example, as described above, the initializer 106 reads initial machine resource values from the test case 102 and may write such values to the microprocessor design 110, either directly, or indirectly through the simulator input 108 and the simulator 112.

Software tools such as the initializer 106 and simulator 112 typically use functions (also referred to as procedures and subroutines) implemented in computer programming languages to read and write machine resource values. Such functions are referred to herein generally as “machine resource access functions.” The SetResource subroutine 406 illustrated in FIG. 4B may be implemented as such a function. In a mixed-scope architecture, resources having varying scope may be referenced using different numbers of identifiers. For example, an MSR having thread-specific scope requires four identifiers—a core number, thread number, offset, and index—to be uniquely referenced, while an MSR having chip-specific scope requires only two identifiers—an offset and index—to be uniquely referenced.

One way to implement machine resource access functions for accessing machine resource representations of varying scope would be to provide a distinct set of functions for each scope. For example, in place of the single SetResource subroutine illustrated in FIG. 4B, one could provide a SetChipResource function to set the value of a resource having chip-specific scope, a SetCoreResource function to set the value of a resource having core-specific scope, and a SetThreadResource function to set the value of a resource having thread-specific scope. Each of these functions would take a different number of parameters as inputs. For example, the SetChipResource function would take as inputs three parameters (index, offset, and value), the SetCoreResource function would take as inputs four parameters (core, index, offset, and value), and the SetThreadResource function would take as inputs five parameters (core, thread, index, offset, value).

Use of such multiple functions would be redundant and inefficient, particularly because it is desirable for tools such as the initializer 106 and simulator 112 to be able to access machine resources of varying scope in the same way. The SetResource subroutine 406 described herein allows machine resources of varying scope to be accessed using a single subroutine, which simplifies the process of designing and maintaining tools such as the initializer 106 and the simulator 112.

In an object-oriented programming language, such as C++, a distinct class could be defined for each scope of machine resource, and a different version of the SetResource subroutine 406 (referred to as a “method” in object-oriented programming) could be implemented for each such class. Each version of the SetResource subroutine could have a different number of parameters. Such an approach would still, however, require that different versions of the SetResource subroutine be coded (one for each resource scope). Furthermore, the techniques described herein enable machine resource representations of varying scope to be accessed through a single software interface even when a non-object-oriented programming language, such as C, is used.

A further advantage of the techniques described herein is that they enable a single data structure (e.g., a data structure having the fields 202a-g illustrated in FIG. 2) to represent machine resources of varying scopes. In particular, the use of the NULL value as a place-holder in the case of values which are not needed for particular resources enables a single data structure type to represent resource definitions of varying scope. Similarly, the use of the NULL value as a place-holder in the resource initialization records 304a-f enables all of the resources initialization records 304a-f in the test case 102 to be implemented using a single data structure type.

Another advantage of techniques described herein is that they interpret and apply the probable intent of the initialization records in the test case 102 during the initialization process. For example, alternative approaches to handling machine resource references in the test case 102 that either over- or under-specify machine resources in the resource database 104 include ignoring such references and halting the initializer 106 with an error message. Although either of these approaches may be acceptable in particular circumstances, in the embodiments described herein the initializer 106 resolves the scope specified by the resource initialization records in the test case 102 in an attempt to identify the machine resources to which such records are likely intended to refer.

The method 400, for example, incorporates certain assumptions about the probable intent behind resource references that over- and under-specify machine resources. If, for example, a resource initialization record under-specifies a particular defined resource, the SetResource subroutine 406 (FIG. 4B) assumes that the resource initialization record is intended to apply to the defined resource (step 420), and therefore initializes the defined resource with the initial value specified by the resource initialization record. Embodying this assumption in the initializer 106 allows the initialization process to proceed (rather than terminate) even when resources are under-specified.

Furthermore, embodying this assumption in the initializer 106 allows the test case designer to initialize all resources within a particular scope using a single initialization record. For example, the test case designer may initialize all threads within a particular core by providing a single initialization record which specifies that core but which does not specify a particular thread. In this way, the techniques disclosed herein may save the test case designer time and effort.

It should be appreciated, however, that the initializer 106 may be implemented to embody alternative assumptions. For example, in an alternative embodiment, the SetResource routine 406 may alert the user (step 424) if a resource initialization record under-specifies a defined resource, rather than initialize the defined resource using the resource initialization record.

Similarly, the embodiment of the SetResource routine 406 illustrated in FIG. 4B alerts the user (step 424) if the resource initialization record R over-specifies the resource defined by resource definition D, based on an assumption embodied in the SetResource routine 406 that an over-specified resource is the result of an error on the part of the designer of the test case 102. Alternatively, however, the SetResource routine 406 may be implemented to initialize the resource defined by resource definition D (step 422) if the resource is over-specified by resource initialization record R. It should therefore be appreciated that, more generally, the initializer 106 may be implemented to interpret the test case 102 in any of a variety of ways and to produce the simulator input 108 based on the interpretation(s) applied in each particular case.

Although the particular examples described herein relate to the initializer 106 and simulator 112, it should be appreciated that the techniques described herein may be applied more generally to accessing (i.e., reading and/or writing) machine resources having varying scopes. For example, automated circuit design analysis tools are commonly used to analyze properties of simulated circuit designs, such as the microprocessor design 110. Design analysis tools are therefore another example of tools which may incorporate the techniques described herein.

Furthermore, although the examples above are described with respect to machine-specific registers (MSRs), this is merely an example and not a limitation of the present invention. Rather, the techniques disclosed herein may be applied to any kind of machine resource, such as caches, main memory, and other kinds of registers. Furthermore, although MSRs are described herein as being specified by a combination of core, thread, index, and offset numbers, this is merely an example and not a limitation of the present invention. Rather, a particular resource type may be specified by any number and combination of identifiers. Different kinds of resources in the microprocessor design 110 may be specified by different numbers and/or types of identifiers. Furthermore, although in the examples described above, two identifiers (core number and thread number) are capable of having NULL values, this is not a limitation of the present invention. Rather, any number of identifiers may be capable of having NULL values.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

The description herein refers to the use of a NULL value, for example, with respect to the resource definitions 204a-l in the resource database 104 (FIG. 2), the resource initialization records 304a-f in the test case 102 (FIG. 3), and the parameters passed to the SetResource subroutine 406 (FIG. 4B) and the GetScope subroutine 410 (FIG. 4C). The NULL value may be implemented in any of a variety of ways. For example, the NULL value may be represented by a value, such as −1, which does not represent a valid parameter value in the context in which it is used. Such a value may not be valid, for example, because it is out of range or because it is an undefined value. For example, in a system in which cores are numbered sequentially beginning with zero, a core number of −1 is out of range and may therefore represent the NULL value. Alternatively, some computer programming environments define non-numeric values (such as values indicating an arithmetic overflow) which may be used as the NULL value.

The NULL value may be represented by the same or different values in different contexts. For example, the NULL value in the resource database 104 (FIG. 2) may be represented by −1, while the NULL value in the test case 102 (FIG. 3) may be represented by −1 or another value, such as 999. The GetScope subroutine 410 (FIG. 4C) may determine whether the thread number R_{T} and/or the core number R_{C} is equal to NULL using any of a variety of techniques. For example, if elements of the system 100 are implemented using the C programming language, a common C header file may be provided which defines the NULL value for use in the resource database 104, the test case 102, and the GetScope subroutine 410.

Although in the embodiment described above with respect to FIG. 4A, the initializer 106 applies under-specified machine resource references to all machine resource representations within their scope, this is not a requirement of the present invention. The initializer 106 may, for example, prohibit one or more resources and/or resource types from being under-specified. For example, the initializer 106 may maintain a list of exceptions which lists individual machine resources and/or machine resource types (e.g., cache, register, or main memory) for which under-specification is not allowed. In such a case, the SetResource routine 406, for example, may be modified to alert the user, terminate with an error, or perform another appropriate action if it is determined in step 420 that the specified scope R_{S} is greater than the actual scope D_{S} and the resource defined by resource definition D is on the initializer's exception list.

Elements and components described herein may be further divided into additional components or joined together to form fewer components for performing the same functions.

Although the examples described herein are described in relation to the microprocessor design 110, it should be appreciated that the techniques described herein may be applied more broadly to any kind of circuit design.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and nonvolatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. In a system including a plurality of representations of machine resources in a microprocessor design, the plurality of machine resource representations having a plurality of scopes, a method comprising steps of:
(A) identifying a scope specified by a machine resource reference;
(B) identifying a scope of one of the plurality of machine resource representations;
(C) determining whether the scope specified by the machine resource reference is the same as the scope of the identified machine resource representation; and
(D) assigning to the identified machine resource representation a value specified by the machine resource reference if the scope specified by the machine resource reference is determined to be the same as the scope of the identified machine resource representation.

2. The method of claim 1, wherein the machine resource reference comprises a first parameter value, wherein the first parameter value comprises a value of a first parameter having a first set of valid values, and wherein the step (A) comprises steps of:
(A)(1) determining whether the first parameter value is a member of the first set of valid values;
(A)(2) identifying the scope specified by the machine resource reference as a first scope if the first parameter value is determined to be a member of the first set of valid values; and
(A)(3) identifying the scope specified by the machine resource reference as a second scope if the first parameter value is determined not to be a member of the first set of valid values, wherein the second scope is broader than the first scope.

3. The method of claim 2, wherein the step (A)(1) comprises a step of determining whether the first parameter value is a NULL value.

4. The method of claim 3, wherein the NULL value comprises −1.

5. The method of claim 2, wherein the microprocessor design comprises a multi-thread microprocessor design, wherein the first parameter comprises a parameter specifying a thread in the microprocessor design, wherein the first scope comprises a thread-specific scope, and wherein the second scope comprises a core-specific scope.

6. The method of claim 2, wherein the microprocessor design comprises a multi-core microprocessor design, wherein the first parameter comprises a parameter specifying a core in the microprocessor design, wherein the first scope comprises a core-specific scope, and wherein the second scope comprises a chip-specific scope.

7. The method of claim 2, wherein the machine resource reference comprises a second parameter value, wherein the second parameter value comprises a value of a second parameter having a second set of valid values, and wherein the step (A) further comprises steps of:
(A)(4) determining whether the second parameter value is a member of the second set of valid values;
(A)(5) identifying the scope specified by the machine resource reference as the second scope if the second parameter value is determined to be a member of the second set of valid values; and
(A)(6) identifying the scope specified by the machine resource reference as a third scope if the second parameter value is determined not to be a member of the second set of valid values, wherein the third scope is broader than the second scope.

8. The method of claim 7, wherein the microprocessor design comprises a multi-core and multi-thread microprocessor design, wherein the first parameter comprises a parameter specifying a thread in the microprocessor design, wherein the first scope comprises a thread-specific scope, wherein the second parameter comprises a parameter specifying a core in the microprocessor design, wherein the second scope comprises a core-specific scope, and wherein the third scope comprises a chip-specific scope.

9. The method of claim 1, further comprising steps of:
(E) determining whether the scope specified by the machine resource reference is broader than the scope of the identified machine resource representation; and
(F) assigning to the identified machine resource representation the value specified by the machine resource reference if the scope specified by the machine resource reference is determined to be broader than the scope of the identified machine resource representation.

10. The method of claim 1, further comprising steps of:
(E) determining whether the scope specified by the machine resource reference is narrower than the scope of the select one of the plurality of machine resource representations; and
(F) signaling an error if the first scope is determined to be narrower than the second scope.

11. A system comprising:
a plurality of representations of machine resources in a microprocessor design, the plurality of machine resource representations having a plurality of scopes;
first scope-identifying means for identifying a scope specified by a machine resource reference;
second scope-identifying means for identifying a scope of one of the plurality of machine resource representations;
means for determining whether the scope specified by the machine resource reference is the same as the scope of the identified machine resource representation; and
means for assigning to the identified machine resource representation a value specified by the machine resource reference if the scope specified by the machine resource reference is determined to be the same as the scope of the identified machine resource representation.

12. The system of claim 11, wherein the machine resource reference comprises a first parameter value, wherein the first parameter value comprises a value of a first parameter having a first set of valid values, and wherein the first scope-identifying means comprises:
means for determining whether the first parameter value is a member of the first set of valid values;
means for identifying the scope specified by the machine resource reference as a first scope if the first parameter value is determined to be a member of the first set of valid values; and
means for identifying the scope specified by the machine resource reference as a second scope if the first parameter value is determined not to be a member of the first set of valid values, wherein the second scope is broader than the first scope.

13. The system of claim 12, wherein the means for determining whether the first parameter value is a member of the first set of valid values comprises means for determining whether the first parameter value is a NULL value.

14. The system of claim 13, wherein the NULL value comprises −1.

15. The system of claim 12, wherein the microprocessor design comprises a multi-thread microprocessor design, wherein the first parameter comprises a parameter specifying a thread in the microprocessor design, wherein the first scope comprises a thread-specific scope, and wherein the second scope comprises a core-specific scope.

16. The system of claim 12, wherein the microprocessor design comprises a multi-core microprocessor design, wherein the first parameter comprises a parameter specifying a core in the microprocessor design, wherein the first scope comprises a core-specific scope, and wherein the second scope comprises a chip-specific scope.

17. The system of claim 12, wherein the machine resource reference comprises a second parameter value, wherein the second parameter value comprises a value of a second parameter having a second set of valid values, and wherein the first scope-identifying means further comprises:
means for determining whether the second parameter value is a member of the second set of valid values;
means for identifying the scope specified by the machine resource reference as the second scope if the second parameter value is determined to be a member of the second set of valid values; and
means for identifying the scope specified by the machine resource reference as a third scope if the second parameter value is determined not to be a member of the second set of valid values, wherein the third scope is broader than the second scope.

18. The system of claim 17, wherein the microprocessor design comprises a multi-core and multi-thread microprocessor design, wherein the first parameter comprises a parameter specifying a thread in the microprocessor design, wherein the first scope comprises a thread-specific scope, wherein the second parameter comprises a parameter specifying a core in the microprocessor design, wherein the second scope comprises a core-specific scope, and wherein the third scope comprises a chip-specific scope.

19. The system of claim 11, further comprising:
means for determining whether the scope specified by the machine resource reference is broader than the scope of the identified machine resource representation; and
means for assigning to the identified machine resource representation the value specified by the machine resource reference if the scope specified by the machine resource reference is determined to be broader than the scope of the identified machine resource representation.

20. The system of claim 11, further comprising:
means for determining whether the scope specified by the machine resource reference is narrower than the scope of the select one of the plurality of machine resource representations; and
means for signaling an error if the first scope is determined to be narrower than the second scope.

21. The system of claim 11, wherein the first scope-identifying means comprises a software function implemented in a computer programming language.

22. The system of claim 21, wherein the computer programming language comprises the C programming language.

23. The system of claim 11, wherein the second scope-identifying means, the means for determining, and the means for assigning comprise a single software function implemented in a computer programming language.

24. The system of claim 23, wherein the computer programming language comprises the C programming language.

25. In a system including a plurality of representations of machine resources in a microprocessor design, the plurality of machine resource representations having a plurality of scopes, a method comprising steps of:
(A) identifying a machine resource reference comprising a first parameter value, wherein the first parameter value comprises a value of a first parameter having a first set of valid values;
(B) determining whether the first parameter value is a member of the first set of valid values;
(C) identifying the scope specified by the machine resource reference as a first scope if the first parameter value is determined to be a member of the first set of valid values; and
(D) identifying the scope specified by the machine resource reference as a second scope if the first parameter value is determined not to be a member of the first set of valid values, wherein the second scope is broader than the first scope.

26. The method of claim 25, wherein the step (B) comprises a step of determining whether the first parameter value is a NULL value.

27. The method of claim 26, wherein the NULL value comprises −1.

28. The method of claim 25, wherein the microprocessor design comprises a multi-thread microprocessor design, wherein the first parameter comprises a parameter specifying a thread in the microprocessor design, wherein the first scope comprises a thread-specific scope, and wherein the second scope comprises a core-specific scope.

29. The method of claim 25, wherein the microprocessor design comprises a multi-core microprocessor design, wherein the first parameter comprises a parameter specifying a core in the microprocessor design, wherein the first scope comprises a core-specific scope, and wherein the second scope comprises a chip-specific scope.

30. The method of claim 25, wherein the machine resource reference comprises a second parameter value, wherein the second parameter value comprises a value of a second parameter having a second set of valid values, and wherein the method further comprises steps of:
(E) determining whether the second parameter value is a member of the second set of valid values;
(F) identifying the scope specified by the machine resource reference as the second scope if the second parameter value is determined to be a member of the second set of valid values; and
(G) identifying the scope specified by the machine resource reference as a third scope if the second parameter value is determined not to be a member of the second set of valid values, wherein the third scope is broader than the second scope.

31. The method of claim 30, wherein the microprocessor design comprises a multi-core and multi-thread microprocessor design, wherein the first parameter comprises a parameter specifying a thread in the microprocessor design, wherein the first scope comprises a thread-specific scope, wherein the second parameter comprises a parameter specifying a core in the microprocessor design, wherein the second scope comprises a core-specific scope, and wherein the third scope comprises a chip-specific scope.

32. A system comprising:
a plurality of representations of machine resources in a microprocessor design, the plurality of machine resource representations having a plurality of scopes;
means for identifying a machine resource reference comprising a first parameter value, wherein the first parameter value comprises a value of a first parameter having a first set of valid values;
means for determining whether the first parameter value is a member of the first set of valid values;
means for identifying the scope specified by the machine resource reference as a first scope if the first parameter value is determined to be a member of the first set of valid values; and
means for identifying the scope specified by the machine resource reference as a second scope if the first parameter value is determined not to be a member of the first set of valid values, wherein the second scope is broader than the first scope.

33. The system of claim 32, wherein the means for determining comprises means for determining whether the first parameter value is a NULL value.

34. The system of claim 33, wherein the NULL value comprises −1.

35. The system of claim 33, wherein the microprocessor design comprises a multi-thread processor design, wherein the first parameter comprises a parameter specifying a thread in the microprocessor design, wherein the first scope comprises a thread-specific scope, and wherein the second scope comprises a core-specific scope.

36. The system of claim 32, wherein the microprocessor comprises a multi-core microprocessor design, wherein the first parameter comprises a parameter specifying a core in the microprocessor design, wherein the first scope comprises a core-specific scope, and wherein the second scope comprises a chip-specific scope.

37. The system of claim 32, wherein the machine resource reference comprises a second parameter value, wherein the second parameter value comprises a value of a second parameter having a second set of valid values, and wherein the system further comprises:
means for determining whether the second parameter value is a member of the second set of valid values;
means for identifying the scope specified by the machine resource reference as the second scope if the second parameter value is determined to be a member of the second set of valid values; and
means for identifying the scope specified by the machine resource reference as a third scope if the second parameter value is determined not to be a member of the second set of valid values, wherein the third scope is broader than the second scope.

38. The system of claim 37, wherein the microprocessor design comprises a multi-core and multi-thread microprocessor design, wherein the first parameter comprises a parameter specifying a thread in the microprocessor design, wherein the first scope comprises a thread-specific scope, wherein the second parameter comprises a parameter specifying a core in the microprocessor design, wherein the second scope comprises a core-specific scope, and wherein the third scope comprises a chip-specific scope.
